(19) United States
(12) Patent Application Publication
(10) Pub. No.: US 2010/0312633 A1
(43) Pub. Date: Dec. 9, 2010

(54) DUAL RANGE CELLULAR TELEPHONE COUPON CARD GENERATION

(76) Inventor: Karen L. Cervenka, Belmont, CA (US)

Correspondence Address: Quarles & Brady LLP, TWO NORTH CENTRAL AVENUE, One Renaissance Square, PHOENIX, AZ, 85004-2391, US

(21) Appl. No.: 12/480,346

(22) Filed: Jun. 8, 2009

(51) Int. Cl. G06Q 30/00; G06F 17/30; H04M 3/42

(52) U.S. Cl. 705/14.38; 705/14.39; 707/E17.014; 455/414.1

(57) ABSTRACT

A method for use in a payment processing network is provided. The method includes browsing to an Internet website in communication with a web service having a database storing electronic coupons. Each electronic coupon is associated with a sponsor's account and is receivable by a merchant for a discount, where the discount is debited from the sponsor's account and credited to the merchant's. The browser sends the selected electronic coupon and a specification including the rendering capability of the client, the type of portable coupon device, and an identifier for the consumer account associated with the portable coupon device. The browser then receives a rendering image, the memory storage location for the discount information, and the discount information, which includes identifiers for the sponsor account, the discount amount, and the eligible purchase. Finally the discount information is written to the memory of the portable coupon device.

### CROSS NOTING

The case is filed concurrently with U.S. patent application Ser. No. ______, by Karen Cervenka, titled Coupon Card Generation Web Service, and with U.S. patent application Ser. No. ______, by Karen Cervenka, titled Transaction Handler Merchant Reimbursement For Consumer Transaction Use Of Sponsor Discount Coupon Card, and with U.S. patent application Ser. No. ______, by Karen Cervenka, titled Coupon Card Kiosk, and with U.S. patent application Ser. No. ______, by Karen Cervenka, titled Coupon Card Point Of Service Terminal Processing, each of which is incorporated herein by reference.

### FIELD

The present invention is related to a transaction between a merchant and a consumer, is more particularly related to a discount on such a transaction, and is most particularly related to a coupon being presented by the consumer to the merchant to obtain the discount on the transaction.

### BACKGROUND

Consumers obtain paper coupons in a variety of ways. They may cut them out of a newspaper or receive them at a Point of Service (POS) terminal when making a purchase. Sometimes paper coupons are mailed to consumers by the sponsor of the paper coupon or other entity. Each of these distribution methods, however, are associated recurring costs. Every time a manufacturer or merchant decides to offer a paper coupon they must pay to have them printed and distributed.

Moreover, paper coupons are cumbersome and easily lost. Many consumers spend valuable time clipping the paper coupons they want from newspapers. Those who use a large number of paper coupons often spend additional time sorting the paper coupons into categories so that a particular paper coupon is easier to find. Further, customers will often receive the paper coupon some time before they intend to use it. The consumer must then store the paper coupon until they go shopping.

Additionally, consumers may not receive paper coupons for specific items they buy even though the paper coupons are available from a manufacturer or merchant. The consumer may not be on the mailing list to receive the paper coupon or it may not have been printed in the newspaper they buy. In some cases this may cause the consumer to forego purchasing a specific item in favor of a less costly alternative.

Thus, there is a need for a system that reduces the costs incurred by merchants and manufacturers in offering coupons as well as one that allows consumers to be able to quickly find and obtain the coupons they want.

### SUMMARY

In one implementation, a method for use in a payment processing network is provided. The method includes browsing, using a cellular telephony capability of a web enabled client (e.g., a web enabled cell phone), via a browser to an Internet website in communication with a web service having a database storing multiple electronic coupons. Each electronic coupon is associated with an account of the electronic coupon's sponsor and is receivable by a merchant for a discount on a purchase, where the discount is debited from the sponsor's account and credited to the merchant's to reimburse the merchant. Next, using the cellular telephony capability of the web enabled client, the browser sends a user's selection of an electronic coupon and a specification. The specification includes the rendering capability of the web enabled client to render a soft copy of the electronic coupon on a display, the type of a portable coupon device being used, and an identifier for the consumer account associated with the portable coupon device. The browser then receives, using the cellular telephony capability of the web enabled client, a rendering image, the location at which to store the discount information in memory of the portable coupon device, and the discount information. The discount information includes identifiers for the sponsor account, the discount amount, and the purchase that is eligible for the discount. Finally, using the near field communication capability of the web enabled client, the discount information is written to the specified location in the memory of the portable coupon device.

In another implementation, a web enabled client is presented. The web enabled client includes a browser for browsing to a website, a means for sending from the browser, a means for receiving at the browser, and a means for writing to a portable coupon card. The website is in communication with a web service having a database storing electronic coupons. Each electronic coupon is associated with the account of the electronic coupon's sponsor and is receivable by a merchant for a discount on a purchase, where the discount is debited from the sponsor's account and credited to the merchant's to reimburse the merchant.

In yet another implementation, a method for use in a payment processing network is presented. The method includes providing a portable coupon device for reading by a point of service terminal, where the portable coupon device is associated with a consumer account and has an electronic coupon stored in memory. The electronic coupon is associated with the account of the electronic coupon's sponsor and is receivable by a merchant for a discount on a purchase, where the discount is debited from the sponsor's account and credited to the merchant's to reimburse the merchant. Also stored in memory is discount information which includes identifiers for the sponsor's account, a discount amount, and the purchase that is eligible for the discount. The memory of the portable coupon device presented is to be read, thereby providing the point of service terminal with sufficient information to start the process of debiting the consumer account for the price of the purchase less the discount amount, debiting the sponsor's account for the discount amount, and crediting the merchant's account with the discount amount.

### BRIEF DESCRIPTION OF THE DRAWINGS

Implementations of the invention will become more apparent from the detailed description set forth below when taken in conjunction with the drawings, in which like elements bear like reference numerals.

FIG. 1 illustrates an exemplary payment processing network, depicting the general environment where a coupon card may be used by a consumer to obtain a discount on a purchase;

FIG. 2 depicts the environment within FIG. 1 where a consumer selects electronic coupons for storage on a coupon card using a cellular telephone and uses the coupon card to obtain a discount on a purchase;

FIG. 3 illustrates an exemplary cellular phone capable of being used within the environment depicted in FIG. 2;

FIG. 4 illustrates possible alternative implementations of the data encoding area of a coupon card.

### DETAILED DESCRIPTION

The present discussion considers the distribution of electronic coupons to consumers via a dual range cellular telephone and their use for obtaining discounts on goods or services.

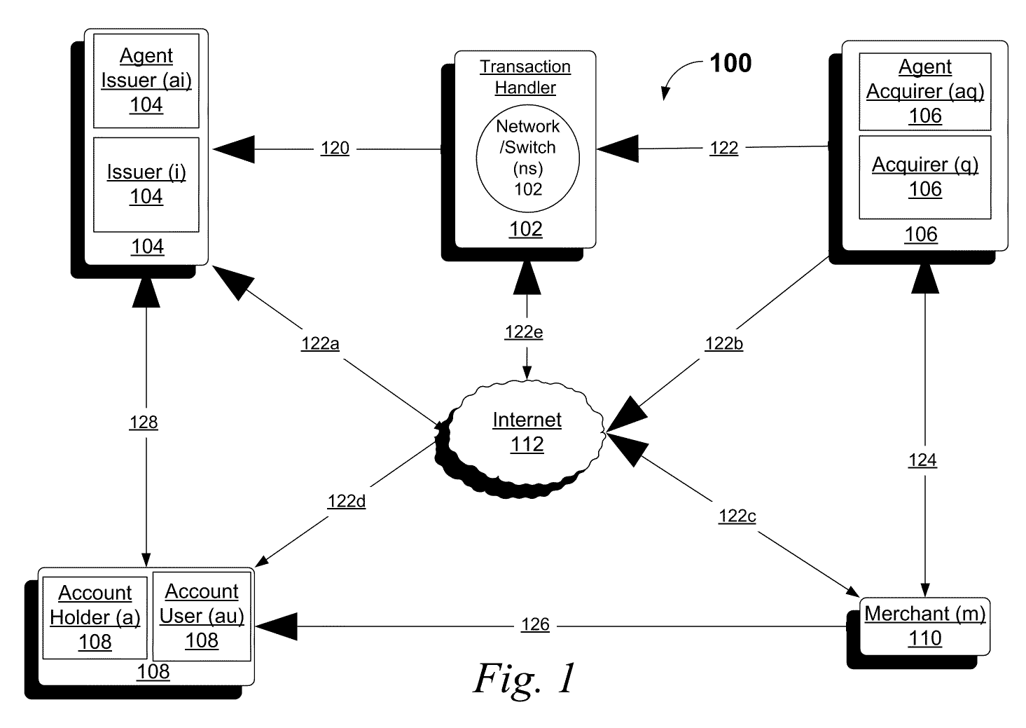

FIG. 1 illustrates an exemplary payment processing system 100, depicting a general environment in which a merchant (m) 110 can conduct a transaction for goods and/or services with an account user (au) on an account (i.e., a prepaid account) issued to an account holder (a) 108 by an issuer (i) 104, where the processes of paying and being paid for the transaction are coordinated by a transaction handler 102. The transaction includes participation from different entities that are each a component of the payment processing system 100.

Payment processing system 100 has a plurality of merchants 110 that includes merchant (1) 110 through merchant (M) 110, where M can be up to and greater than an eight digit integer.

Payment processing system 100 has a plurality of prepaid accounts 108 each of which is held by a corresponding account holder (1) 108 through account holder (A) 108, where A can be up to and greater than a ten eight digit integer.

Payment processing system 100 includes account user (1) 108 through account user (AU) 108, where AU can be as large as a ten digit integer or larger. Each account user (au) conducts a transaction for goods and/or services with merchant (m) 110 using an account (i.e., a prepaid account) that has been issued by an issuer (i) 104 to a corresponding account holder (a) 108. Data from the transaction on the account is collected by merchant (m) and forwarded to a corresponding acquirer (a) 106. Acquirer (a) 106 forwards the data to transaction handler 102 who facilitates payment for the transaction from the prepaid account issued by the issuer (i) 104 to account holder (a) 108.

Payment processing system 100 has a plurality of issuers 104. Each issuer (i) 104 may be assisted in processing one or more transactions by a corresponding agent issuer (ai) 104, where ‘i’ can be an integer from 1 to I, where ‘ai’ can be an integer from 1 to AI, and where I and AI can be as large as an eight digit integer or larger.

Payment processing system 100 has a plurality of acquirers 106. Each acquirer (q) 106 may be assisted in processing one or more transactions by a corresponding agent acquirer (aq) 104, where ‘q’ can be an integer from 1 to Q, where aq can be an integer from 1 to AQ, and where Q and AQ can be as large as a eight digit integer or larger.

Payment processing system 100 has a transaction handler 102 to process a plurality of transactions. The transaction handler 102 can include one or a plurality or networks and switches 102. Each network/switch (ns) 102 can be a mainframe computer in a geographic location different than each other network/switch (ns) 102, where ‘ns’ is an integer from one to NS, and where NS can be as large as a four digit integer or larger.

Dedicated communication systems 120, 122 (i.e., private communication network(s)) facilitate communication between the transaction handler 102 and each issuer (i) 104 and each acquirer (a) 106. The Internet 112, via e-mail, the World Wide Web, cellular telephony, and/or other optional public and private communications systems, can facilitate communications 122a-122e among and between each issuer (i) 104, each acquirer (a) 106, each merchant (m) 110, each account holder (a) 108, and the transaction handler 102. Alternatively and optionally, one or more dedicated communication systems 124, 126, and 128 can facilitate respective communications between each acquirer (a) 106 and each merchant (m) 110, each merchant (m) and each account holder (a) 108, and each account holder (a) 108 and each issuer (i) 104, respectively.

Each acquirer (q) 106 may be assisted in processing one or more transactions by a corresponding agent acquirer (aq) 104, where ‘q’ can be an integer from 1 to Q, where aq can be an integer from 1 to AQ, and where Q and AQ can be as large as a eight digit integer or larger.

Merchant (m) 110 may be a person or entity that sells goods and/or services. Merchant (m) 110 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder (a) 108 may be a second merchant making a purchase from another merchant (m) 110. Merchant (m) 110 may utilize at least one point-of-sale terminal (POS) that can communicate with acquirer (a) 106, transaction handler 102, or issuer (i) 104. Thus, the POS terminal is in operative communication with the payment processing system 100.

Typically, a transaction begins with account user (au) 108 presenting a portable consumer device to merchant (m) 110 to initiate an exchange for a good or service. The portable consumer device may be associated with an account (e.g., a prepaid account) of account holder (a) 108 that was issued to the account holder (a) 108 by issuer (i) 104.

The portable consumer device may be in a form factor that can be a payment card, a gift card, a smartcard, a smart media, a payroll card, a healthcare card, a wrist band, a machine readable medium containing account information, a keychain device, such as a SPEEDPASS® device commercially available from ExxonMobil Corporation, or a supermarket discount card, a cellular phone, personal digital assistant, a pager, a security card, an access card, a wireless terminal, or a transponder. The portable consumer device may include a volatile or non-volatile memory to store information such as the account number or an account holder (a) 108's name.

Merchant (m) 110 may use the POS terminal to obtain account information, such as a number of the account of the account holder (a) 108, from the portable consumer device. The portable consumer device may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request to the issuer (i) 104 of the account corresponding to the portable consumer device. Alternatively, or in combination, the portable consumer device may communicate with issuer (i) 104, transaction handler 102, or acquirer (a) 106.

Issuer (i) 104 may authorize the transaction using transaction handler 102. Transaction handler 102 may also clear the transaction. Authorization includes issuer (i) 104, or transaction handler 102 on behalf of issuer (i) 104, authorizing the transaction in connection with issuer (i) 104's instructions such as through the use of business rules. The business rules could include instructions or guidelines from transaction handler 102, account holder (a) 108, merchant (km) 110, acquirer (a) 106, issuer (i) 104, a related financial institution, or combinations thereof. Transaction handler 102 may maintain a log or history of authorized transactions. Once approved, merchant (m) 110 will record the authorization, allowing account user (au) 108 to receive the good or service from merchant (m) or an agent thereof.

Merchant (m) 110 may, at discrete periods, such as the end of the day, submit a list of authorized transactions to acquirer (a) 106 or other transaction related data for processing through the payment processing system 100. Transaction handler 102 may compare the submitted authorized transaction list with its own log of authorized transactions. If a match is found, transaction handler 102 may route authorization transaction amount requests from the corresponding acquirer (a) 106 to the corresponding issuer (i) 104 involved in each transaction. Once acquirer (a) 106 receives the payment of the authorized transaction amount from issuer (i) 104, acquirer (a) 106 can forward the payment to merchant (m) 110 less any transaction costs, such as fees for the processing of the transaction. If the transaction involves a debit or pre-paid card, acquirer (a) 106 may choose not to wait for the issuer (i) 104 to forward the payment prior to paying merchant (m) 110.

There may be intermittent steps in the foregoing process, some of which may occur simultaneously. For example, acquirer (a) 106 can initiate the clearing and settling process, which can result in payment to acquirer (a) 106 for the amount of the transaction. Acquirer (a) 106 may request from transaction handler 102 that the transaction be cleared and settled. Clearing includes the exchange of financial information between the issuer (i) 104 and the acquirer (a) 106 and settlement includes the exchange of funds. Transaction handler 102 can provide services in connection with settlement of the transaction. The settlement of a transaction includes depositing an amount of the transaction settlement from a settlement house, such as a settlement bank, which transaction handler 102 typically chooses, into a clearinghouse, such as a clearing bank, that acquirer (a) 106 typically chooses. Issuer (i) 104 deposits the same from a clearinghouse, such as a clearing bank, which issuer (i) 104 typically chooses, into the settlement house. Thus, a typical transaction involves various entities to request, authorize, and fulfill processing the transaction.

Payment processing system 100 will preferably have network components suitable for scaling the number and data payload size of transactions that can be authorized, cleared and settled in both real time and batch processing. These include hardware, software, data elements, and storage network devices for the same. Examples of payment processing system 100 include those operated, at least in part, by American Express, Master Card, Discover Card, First Data Corporation, Diners Club, and Visa Inc., and agents of the foregoing.

Each network/switch (ns) 102 can include one or more data centers for processing transactions, where each transaction can include up to 100 kilobytes of data or more. The data corresponding to the transaction can include information about the types and quantities of goods and services in the transaction, information about the account holder (a) 108, the account user (au) 108, the merchant (m) 110, tax and incentive treatment(s) of the goods and services, coupons, rebates, rewards, loyalty, discounts, returns, exchanges, cash-back transactions, etc.

By way of example, network/switch (ns) 102 can include one or more mainframe computers (i.e., one or more IBM mainframe computers) for communications over systems 120, 122, one or more server farms (i.e., one or more Sun UNIX Superservers), where the mainframe computers and server farms can be in diverse geographic locations.

Each issuer (i) 104 (or agent issuer (ai) 104 thereof) and each acquirer (a) 106 (or agent acquirer (aq) 106 thereof) can use or more router/switch (i.e., Cisco routers/switches) to communicate with each network/switch (ns) 102 via dedicated communication systems 120, 122, respectively.

Transaction handler 102 stores information about transactions processed through payment processing system 100 in data warehouses such as may be incorporated as part of the plurality of networks/switches 102. This information can be data mined. The data mining transaction research and modeling can be used for advertising, account holder and merchant loyalty incentives and rewards, fraud detection and prediction, and to develop tools to demonstrate savings and efficiencies made possible by use of the payment processing system 100 over paying and being paid by cash, checks, or other traditional payment mechanisms.

The VisaNet® system is an example component of the transaction handler 102 in the payment processing system 100. Presently, the VisaNet® system is operated in part by Visa Inc. As of 2007, the VisaNet® system Inc. was processing around 300 million transaction daily, on over 1 billion accounts used in over 170 countries. Financial instructions numbering over 16,000 connected through the VisaNet® system to around 30 million merchants. In 2007, around 81 billion transactions for about 4 trillion U.S. dollars were cleared and settled through the VisaNet® system, some which involved a communication length of around 24,000 miles in around two (2) seconds.

In the present context, an account for the payment of future discounts on goods and services attributable to the use of electronic coupons is issued by the issuer to a third-party and credited with funds submitted by the third-party. The funds are for reimbursement of discounts on the sale of goods and services given by a merchant upon the presentation of a coupon card having at least one of the electronic coupons stored thereon.

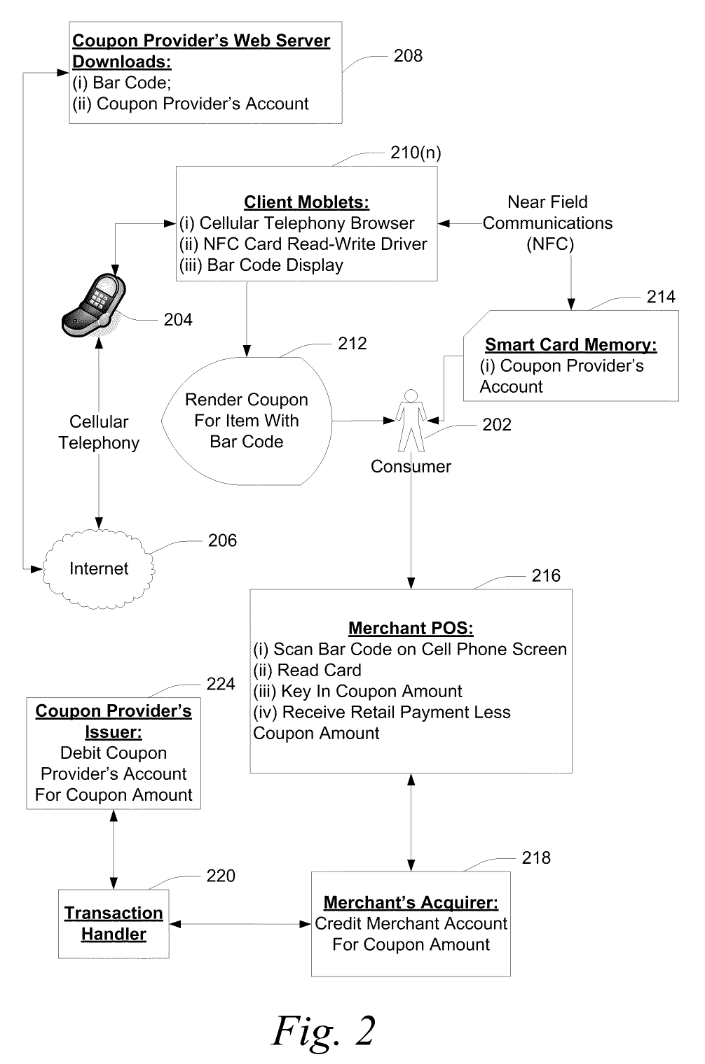

Within the general environment of the exemplary payment processing system depicted in FIG. 1, FIG. 2 illustrates process 200 by which consumer 202 selects an electronic coupon for storage on a coupon card using cellular telephone 204 and subsequently uses the coupon card to obtain a discount on an item. Cellular telephone 204 is a dual range cellular telephone. As will by understood by one of ordinary skill in the art, a dual range cellular telephone is a cellular telephone capable of both far field and near field communication. Near field communication (NFC) is a short-range wireless connectivity standard (Ecma-340, ISO/IEC 18092) that uses magnetic field induction to enable communication between devices when they are brought within close proximity to one another.

Further, cellular telephone 204 is web-enabled. As one of ordinary skill in the art will appreciate, to be “web-enabled” means a client that is able to connect to the World Wide Web via a browser executing on the client. Thus, a web-enabled cellular phone is a cellular telephone that is able to receive voice calls as well as transmit and receive data from the Internet, and specific web pages, or portions thereof, on the World Wide Web. In certain implementations, a web-enabled cellular phone uses a built-in modem to connect to the Internet.

In certain implementations, cellular telephone 204 can also be a personal digital assistant (PDA). In yet other implementations, cellular telephone 204 is a smartphone. In yet other implementations, cellular telephone 204 is any web enabled device that has short and long range (i.e., dual range) wireless capabilites.

In the illustrative implementation of FIG. 2, consumer 202 uses a cellular telephone 204 to connect to the Internet 206 (World Wide Web) and execute a browser application to browse to a website 208 for a web service that serves electronic coupons. In certain implementations, cellular telephone 204 is equipped with a plurality of moblets 210(1)-210(N). One moblet 210(n) of the plurality of moblets 210(1)-210(N) includes a cellular telephony browser. As is known by one of ordinary skill in the art, a moblet is an application which can be used on mobile devices. In certain implementations, cellular telephone 204 is purchased by consumer 202 with some or all of moblets 210(1)-210(N) already stored thereon. In other implementations, some or all of moblets 210(1)-210(N) are downloaded onto cellular telephone 204 by consumer 202.

Website 208 is rendered on display 212 of cellular telephone 204. Website 208 provides access to available electronic coupons. In certain implementations, website 208 is connected, via a web service, to a searchable database having multiple electronic coupons stored therein. In certain implementations, website 208 is a manufacturer's website having electronic coupons for products made by the manufacturer. In other implementations, website 208 is a merchant's website having electronic coupons for products sold by the merchant. In yet other implementations, website 208 is an unrelated party's website. In such an implementation, the unrelated party may be offering electronic coupons as part of a promotional effort, awareness campaign, or any other purpose. Alternatively, the unrelated party may offer a multitude of electronic coupons issued by different manufacturers and merchants for a fee. The fee may be paid by the sponsors of the electronic coupons in return for the service of offering their electronic coupons. Alternatively, the fee may be paid by consumer 202 as a membership fee for access to the electronic coupons.

Consumer 202 selects an electronic coupon from those being offered on website 208. In certain implementations, consumer 202 may additionally send information regarding the web enabled client being used by consumer 202, illustrated in FIG. 2 as cellular telephone 204, and the type of coupon card consumer 202 has. In certain implementations, the information provided includes the rendering capabilities of the web enabled client consumer 202 is using to render an image on a display in communication with the web enabled client. In certain implementations, the information provided includes an account identifier for an account issued to consumer 202 and associated with the portable coupon device.

When an electronic coupon is selected by consumer 202, information relating to that electronic coupon is downloaded to cellular telephone 204, including an account identifier for the third-party sponsor of the electronic coupon. The account identifier, as will be discussed in greater detail below, is associated with an account issued by an issuer to the sponsor of the electronic coupon. The account is credited with funds provided by the offering party to pay for the discount applied when a consumer uses the electronic coupon. The downloaded information further includes the category or type of product or service for which the electronic coupon is valid. By way of example and not limitation, the electronic coupon may be valid for all cleaning products made by a particular manufacturer. Alternatively, the electronic coupon may be valid for a specific dish soap made by the manufacturer.

In certain implementations, the downloaded information includes a merchant or manufacturer with which the electronic coupon is valid. In such an implementation, the electronic coupon may be valid for use only with a particular merchant or only for purchase of a particular manufacturer's product. In other implementations, the downloaded information includes an expiration date, after which the electronic coupon is no longer valid. In yet other implementations, the downloaded information includes the number of goods or services eligible for a discount using the electronic coupon. By way of example and not limitation, the electronic coupon may be valid for discounts on up to three (3) bottles of a pain reliever. Alternatively, the electronic coupon may only be used when ten (10) car washes are purchased at the same time.

In certain implementations, the downloaded information includes a bar code identifying the type of item for which the electronic coupon is valid. As will be understood by one of ordinary skill in the art, a bar code is an optical machine-readable representation of data. In certain implementations, the downloaded bar code uses Universal Product Code (UPC) symbology. In such an implementation, the bar code is capable of being rendered on display 212 such that the bar code can later be scanned by a scanner at a POS terminal to identify the type of item eligible for a discount using the electronic coupon. In such implementations where the downloaded information includes a bar code and where consumer 202 has provided the rendering capability of the web enabled client being used, here illustrated as cellular telephone 204, website 208 will provide a bar code which corresponds to the rendering capabilities of the web enabled client.

In certain implementations, the downloaded information additionally includes an identifier of the item or type of item eligible for a discount where the identifier can be displayed on display 212. The identifier therefore acts as a reminder to the consumer of the electronic coupon that was downloaded. In certain implementations, the identifier is a picture of the discounted item. In other implementations, the identifier is a text description of the discounted item. In certain implementations, the identifier is a combination of text description and a picture.

In certain implementations, the downloaded information additionally includes an advertisement that is capable of being displayed on display 212. In certain implementations, the advertisement is for a soon-to-be-available electronic coupon.

Once the information relating to the selected electronic coupon is downloaded to cellular telephone 204, some of the information may be stored in memory. In some such implementations, the information stored on cellular telephone 204 is ordered to make it easier for consumer 202 to find the specific electronic coupon they wish to use. The ordering may by the item type. Alternatively, the ordering may be alphanumeric, by manufacturer, by merchant, or by any other means of ordering, or a combination thereof. Further, in certain implementations, consumer 202 selects the ordering used.

In certain implementations, the downloaded information additionally includes instructions executable by the web enabled client being used by consumer 202, illustrated in FIG. 2 as cellular telephone 204. By way of example and not limitation, the instructions may include to communicate with coupon card 214, to store information in a specific location in the memory of coupon card 214, to delete information from the memory of cellular telephone 204 and/or coupon card 214 when the coupon has been used, or to render an image on display 212.

The account identifier associated with the sponsor of the electronic coupon is written to coupon card 214 using moblet 210(n) of moblets 210(1)-210(N), where coupon card 214 is a smart cart. In certain implementations, consumer 202 initiates the process. In other implementations, the process is initiated automatically.

Moblet 210(n) includes an NFC card read-write driver capable of using NFC to read and write data to the memory of coupon card 214. Coupon card 214 is a contactless smart card in which the chip generally communicates with moblet 210(n) through radio-frequency identification (RFID) technology.

In certain implementations, coupon card 214 additionally includes a contact area that when inserted in a card read-write device makes contact with electrical connectors capable of writing information to memory. In certain implementations, coupon card 214 additionally has a magnetic stripe. In such an implementation, additional information may be written to or read from the magnetic stripe by a card read-write device.

In certain implementations, coupon card 214 includes both an embedded chip and a magnetic stripe. In certain implementations, the coupon card is also a portable consumer device, such as a credit card, debit card, prepaid card, merchant loyalty card or other such device associated with an account of consumer 202. In such implementations, consumer 202 may use coupon card 214 to both receive a discount on an item and to pay for the purchase price of the item.

Consumer 202 may obtain coupon card 214 by purchasing it from a merchant. Alternatively, consumer 202 may receive coupon card 214 for free. By way of example and not limitation, coupon card 214 may be provided by a grocery store as a promotional item and may only be used for discounts on items purchased at the grocery store. Where coupon card 214 is also a portable consumer device, consumer 202 may receive the coupon card from an issuer.

After information pertaining to the electronic coupon is stored on coupon card 214, coupon card 214 can be used in a future transaction with merchant 216 for a discount on an item. In certain implementations, when purchasing an item, consumer 202 presents coupon card 214 at the POS terminal of merchant 216 and the information stored thereon is read to determine the associated account. In certain implementations, coupon card 214 is read by swiping coupon card 214 through the POS terminal. In certain implementations, coupon card 214 is read by RFID when consumer 202 is near the POS terminal (i.e., a ‘contactless’ transaction). In yet other implementations, to be read, coupon card 214 is inserted into the POS terminal such that external contacts on coupon card 214 establish connectivity with the POS terminal.

In certain implementations, other information is also read, such as, by way of example and not limitation, an expiration date, an item type, or an item quantity. In such implementations, the POS terminal may determine whether the electronic coupon is valid for one of the items being purchased. This may occur, by way of example, and not by way of limitation, by comparing the current date with the expiration data of the electronic coupon. Alternatively, the POS terminal may determine whether consumer 202 has purchased the quantity of the discounted item specified.

Where consumer 202 has additionally downloaded a bar code to cellular telephone 204, consumer 202 may also present display 212 of cellular telephone 204 having the bar code rendered thereon. In such an implementation, the bar code is scanned with a scanner to identify the item, or category of item, that is eligible for the discount. In certain implementations, merchant 216 additionally enters the amount of the discount into the POS terminal.

In some implementations where multiple bar codes have been downloaded, consumer 202 can flag or otherwise mark each bar code corresponding to the items they are purchasing. In certain implementations, an identifier other then the bar code may be flagged. In certain implementations, when consumer 202 presents cellular telephone 204 to merchant 216 only those bar codes that have been flagged are displayed. Alternatively, where cellular telephone 204 displays each bar code individually on display 212, only those bar codes that have been flagged are queued for display. Thus, by way of example and not limitation, a consumer may have downloaded ten (10) electronic coupons, but only found six (6) of the items in the merchant's store. As the consumer finds each of the six (6) items, the consumer flags the bar code or other identifier corresponding to the items. Then, when purchasing the items, the consumer provides the cellular telephone to the cashier with only the bar codes for the six (6) items displayed.

In the illustrative implementation of FIG. 2, Merchant 216 submits the electronic coupon received from consumer 202 to payment processing system 100 (FIG. 1) for authorization in a similar manner to that described in connection with FIG. 1. Specifically, merchant 216 submits a request, including the account identifier of the sponsor of the electronic coupon to acquirer 218 for authorization. Where acquirer 218 is not the same entity as issuer 222, acquirer 218 forwards the request to transaction handler 220. Transaction handler 220 in turn requests that issuer 222 verify that the account associated with the sponsor of the electronic coupon contains sufficient funds to reimburse merchant 216 for the discount. Upon receipt of a reply from issuer 222, transaction handler 220 forwards an authorization response to acquirer 218, who forwards it to merchant 216. Where the authorization response contains an approval of the electronic coupon, consumer 202 is given a discount on the retail purchase price of the item. In certain implementations, merchant 216 additionally invalidates or deletes the electronic coupon stored on coupon card 214.

When merchant 216 submits the transaction to payment processing system 100 (FIG. 1) for clearing and settlement, the account of the sponsor of the electronic coupon is debited for the cost of the discount. Specifically, merchant 216 submits a request for payment to acquirer 218. Where acquirer 218 is not the same entity as issuer 222, acquirer 218 forwards the request to transaction handler 220. Transaction handler 220 in turn requests payment for the discount from issuer 222, where issuer 222 is the issuer of the account associated with the sponsor of the electronic coupon. Issuer 222 debits the account and forwards the payment to transaction handler 220 who forwards the payment to acquirer 218. Finally, acquirer 218 credits the account of merchant 216 with the amount of the discount.

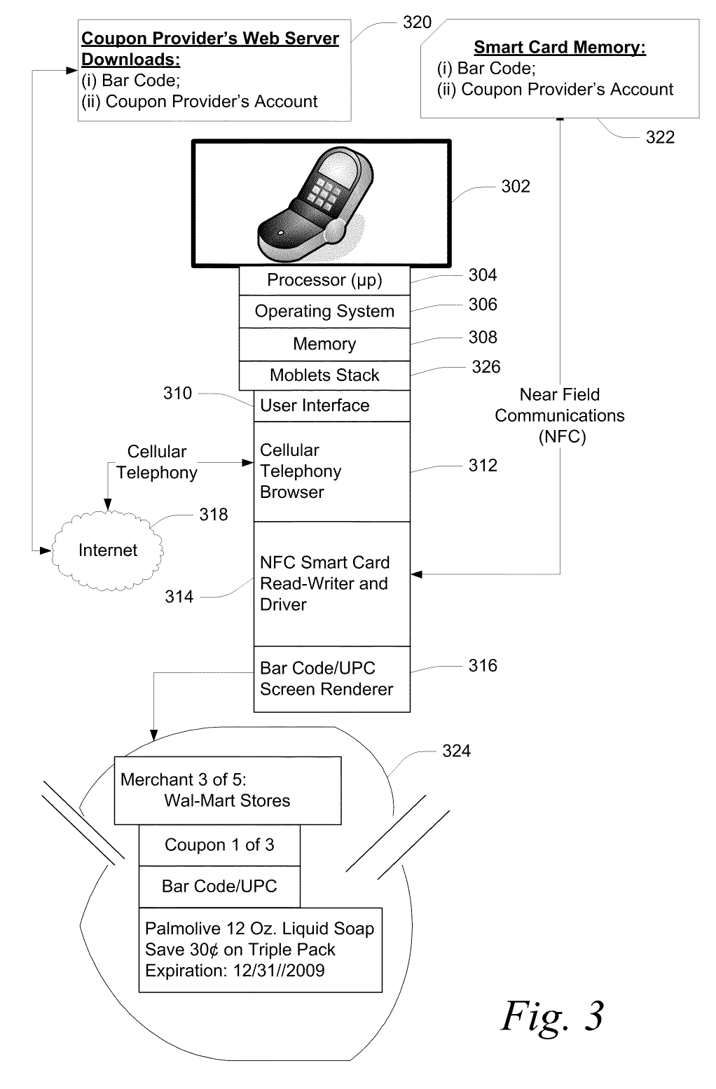

Turning to FIG. 3, a detailed implementation of cellular telephone 302 is presented, where cellular telephone 302 is capable of being used in the exemplary process described in connection with FIG. 2. Cellular telephone 302 is shown having processor 304, operating system 306, memory 308, and moblets stack 326. As will be clear to one of ordinary skill in the art, processor 304 executes instructions stored in memory 326 of cellular telephone 302. Memory 326 is a computer readable medium and may include, without limitation, PROM, EPROM, EEPROM, Flash PROM, compactflash, smartmedia, and the like. Processor 304 may be any computer processor capable of being used in a cellular telephone.

As will also be clear to one of ordinary skill in the art, operating system 306 provides the software infrastructure for cellular telephone 302 and acts as a host for applications that are run on cellular telephone 302. Operating system 306 may be any operating system capable of being used on a cellular telephone.

In the illustrated implementation of FIG. 3, moblets stack 326 is depicted as including four (4) moblets: user interface 310, cellular telephony browser 312, a Near Field Communications (NFC) smart card read-writer application 314, and screen renderer application 316. Each moblet of moblets stack 308 is stored in the memory of cellular telephone 302. In the exemplary process described in connection with FIG. 2, a consumer uses User Interface (UI) 310 of cellular telephone 302 to initiate cellular telephony browser 312, connect to Internet 318, and browse via execution of browser 312 to website 320. As describe with reference to FIG. 2, cellular telephony browser 312 is used to interact with website 320 and download electronic coupons to cellular telephone 302.

Once an electronic coupon has been downloaded to cellular telephone 302, the execution of the smart card read-writer 314, via NFC wireless communications, is used to write to the memory of smart card 322, or otherwise store in the memory of smart card 322, the account identifier associated with the sponsor of the electronic, where smart card 322 is a coupon card. Smart card read-writer 314 may additionally store other information associated with the electronic coupon in the memory of smart card 322 such as, by way of example and not limitation, an expiration date, an item type, or an item quantity.

In certain implementations, cellular telephony browser 312 is also used to download a bar code identifying the item eligible for a discount. Screen renderer 316 is then used to render a scannable bar code on display 324 of cellular telephone 302. In the illustrated implementation of FIG. 3, display 324 is shown as displaying, by way of example, and not limitation, the merchant that the electronic coupon is valid at, how many electronic coupons the consumer downloaded, a scannable bar code for the electronic coupon, and information identifying the item eligible for a discount using the electronic coupon.

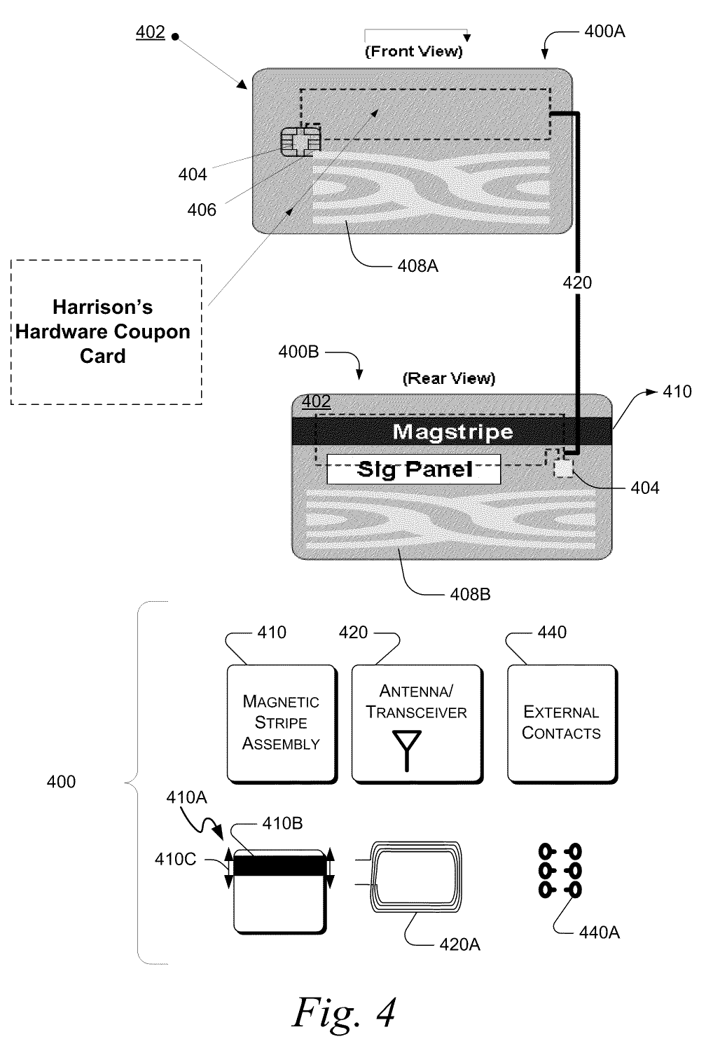

Turning to FIG. 4, both a front view 400A and a rear view 400B of a coupon card 402 are presented. Images may be displayed on both sides of coupon card 402, with image 408A on the front view 400A being either the same as or different from image 408B on the rear view 400B. In this illustration, the front view 400A also displays information about the sponsor of the coupon card.

FIG. 4 also shows exemplary implementations of a data encoding area of coupon card 402. The data encoding area may include an optional shielding element, which allows desired electromagnetic, optical, or radiative signals to penetrate while protecting the data encoding area from physical abuse or damage. Coupon card 402 may optionally have areas outside of the data encoding area shielded from physical abuse or otherwise acceptable forms of electromagnetic radiation. Some of the acceptable signals that are allowed to penetrate the shielding may include, but are not limited to, signals accompanying a magnetic field, RFID signals, IrDA signals, visible light, invisible light, modulated laser, and/or modulated RF communication signals. By way of example and not by way of limitation, a selective shielding element may comprise a clear plastic shield, conformal coatings, an opaque plastic shield, or a clear thin film, depending on the implementation of the data encoding area.

Non-limiting examples of the data encoding area are shown at reference numeral 400, and include a magnetic stripe assembly 410, an antenna and/or transceiver 420, and electrical contacts 440. Magnetic stripe assembly 410 may comprise, in one implementation 410A, a reprogrammable magnetic stripe 410B that accepts data and/or commands from a processor and formats and renders that data into a form on a magnetic stripe that is readable by conventional merchant magnetic stripe-reading point of sale (POS) terminals. In this manner, the processor may program a particular account for use in a transaction as a function of user input selecting the account. Alternatively, the processor may erase the magnetic stripe of assembly 410, rendering the card useless in the event of its loss or theft. In one implementation shown, 410A, magnetic stripe assembly 410B at least partially slidably moves 410C into and out of an assembly of coupon card 402 (partial view shown), allowing coupon card 402 to conduct a transaction at a point of sale terminal that includes a magnetic stripe reader.

Continuing with FIG. 4, another implementation of the data encoding area is shown as an antenna and/or transceiver 420. Antenna and/or transceiver 420 may include commonly used loop inductors such as the one shown, 420A, or in those shown in related ISO standards for RF-readable smart cards. With such an interface, account data may be translated, modulated and transmitted in a manner acceptable by an RF contactless merchant POS terminal, an 802.11 WiFi or WiMax network, or by a cellular or RF communications network. For instance, antenna and/or transceiver 420 may receive NFC communications from a cellular telephone, where the NFC communications carries a manufacturer's discount coupon account that is to be written in memory to the data encoding area 400.

Electrical contacts 440 are yet another alternative implementation of the data encoding area shown in FIG. 4. With coupon card 402 possessing physical contacts such as an array of conductive pads or shapes 440A, the coupon card may be placed in physical contact with a merchant POS terminals, and electrical contacts 440 may establish connectivity to the merchant's financial processing system. The processor may relay account-related information to the merchant POS terminal through the contact interface, thereby allowing coupon card 402 to be utilized with the large number of preexisting merchant POS terminals.

As an example of how the described coupon card may be obtained and used, a consumer may take a coupon card with them to the grocery store. While at the grocery store, the consumer uses their web-enabled cellular telephone to access a website providing electronic coupons from a multitude of merchants and manufacturers. The consumer selects the electronic coupons they want, for example one for bread offered by the manufacturer of the bread, and one for pet food offered by the grocery store the consumer is shopping at. The electronic coupons and associated information are then downloaded to the consumer's cellular telephone. Using the NFC capabilities of the cellular telephone, the account identifiers for the account associated with the manufacturer of the bread and the account associated with the grocery store are written to the memory of the coupon card. While the consumer is shopping, the electronic coupons the consumer downloaded are displayed on the cellular telephone so that the consumer remembers what electronic coupons they selected and can put the corresponding goods into a shopping chart.

At the check-out counter, the consumer provides the coupon card to the cashier. The cashier swipes the magnetic strip of the coupon card through the POS terminal and scans the bar codes displayed on the cellular telephone with a scanner. The cashier then scans the SKU/UPCs (Stock-Keeping Unit/Universal Product Code) for each item the consumer is purchasing that is in the shopping cart. The POS terminal determines if the electronic coupons apply to any of the items by comparing the bar codes with the scanned SKU/UPCs (or other method now in use). For example, the coupon card may contain multiple electronic coupons, one of which is for a discount on bread and is provided by the manufacturer of the bread. Another electronic coupon that is provided by the grocery store which may be for a discount on pet food. When the POS terminal receives the SKU/UPCs for a loaf of bread and a bag of pet food, the POS terminal requests authorization to apply a discount to the items. The authorization request is, for example, received by the grocery store's acquirer.

As the acquirer is the issuer of the account associated with the grocery store, the acquirer verifies if the account has been credited with sufficient funds to pay for the discount on the pet food and sends an authorization response to the POS terminal. The request for authorization to apply a discount to the bread is forwarded by the acquirer to a transaction handler for processing. The transaction handler in turn may forward a request to the issuer of the manufacturer's account for verification that the account contains sufficient funds. Upon receiving a response, the transaction handler may send an authorization response authorizing the application of the discount to the bread.

Once the POS terminal receives the authorization responses for both coupons, the discounts are applied. The consumer may then use the coupon card to pay for the items, where the coupon card is associated with an account of the consumer's (i.e., the consumer's credit card or the consumer's debit card), or the consumer may use an alternative payment method.

The steps, methods, processes, and devices described in connection with the implementations disclosed herein, are made with reference to the Figures, in which like numerals represent the same or similar elements. While described in terms of the best mode, it will be appreciated by those skilled in the art that the description is intended to cover alternatives, modifications, and equivalents as may be included within the spirit and scope of the invention as defined by the appended claims and their equivalents as supported by the following disclosure and drawings. Reference throughout this specification to “one implementation,” “an implementation,” or similar language means that a particular feature, structure, or characteristic described in connection with the implementation is included in at least one implementation of the present invention. Thus, appearances of the phrases “in one implementation,” “in an implementation,” and similar language throughout this specification may, but do not necessarily, all refer to the same implementation.

The described features, structures, or characteristics of the invention may be combined in any suitable manner in one or more implementations. In the above description, numerous specific details are recited to provide a thorough understanding of implementations of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The steps of a method, process, or algorithm described in connection with the implementations disclosed herein may be embodied directly in hardware, in a software module executed by a processor, or in a combination of the two. In certain implementations, instructions are encoded in computer readable medium wherein those instructions are executed by a processor to perform one or more of the steps recited.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. For a payment processing network that includes a plurality of merchants and consumers engaging in a plurality of transactions on a plurality of respective consumer accounts that respective issuers issue to the consumers, each said transaction involving an electronic coupon associated with a sponsor account issued by an issuer, wherein the merchant submits the transaction to an acquirer for processing by a transaction handler who requests the issuer to obtain payment for a discount applied by the merchant to the transaction from the sponsor account, and wherein the issuer forwards the payment to the transaction handler who forwards the payment to the acquirer to reimburse the merchant for the discount given on the transaction, a method comprising:
browsing, using a cellular telephony capability of a web enabled client, via a browser executed by the web enabled client to an Internet website in communication with a web service having a database with a plurality of electronic coupons each:
being associated with a sponsor account issued to a sponsor of a discount by one said an issuer; and
for being receivable by one said merchant to give the discount on a purchase, wherein the discount is to be debited from the sponsor account and credited to one said merchant account issued by another said issuer to the one said merchant to reimburse the one said merchant for the discount;
sending, using the cellular telephony capability of the web enabled client, from the browser:
a selection of at least one said electronic coupon;
and
a specification including:
a rendering capability of the web enabled client to render a soft copy of the at least one said electronic coupon on a display with which the web enabled client is in communication;
a type of a portable coupon device, associated with one said consumer account issued by another said issuer, and acceptable as payment for a future said purchase to be made on the consumer account;
and
an identifier for the one said consumer account to be debited for the payment for the future said purchase less the discount;
receiving, using the cellular telephony capability of the web enabled client, at the browser and in response to the sending:
a rendering image corresponding to the rendering capabilities of the web enabled client to render the soft copy of the at least one said electronic coupon on the display with which the web enabled client is in communication;
a memory location to store discount information in a memory of the type of the portable coupon device; and
discount information including an identifier for:
the sponsor account;
the discount amount; and
the purchase that is eligible for the discount from the merchant and including at least one of a good and a service;
and
writing, using a near field communication capability of the web enabled client, to the memory location in the memory of the portable coupon device the discount information.

2. The method of claim 1, wherein said receiving further comprises downloading, using the cellular telephony capability of the web enabled client, a first instruction executable by the web enabled client to write, using the near field communication capability of the web enabled client, the discount information to the memory of the portable coupon device.

3. The method of claim 2, wherein said receiving further comprises downloading, using the cellular telephony capability of the web enabled client, a second instruction executable by the web enabled client to store, in a memory of the web enabled client, the rendering image.

4. The method of claim 3, further comprising storing, in the memory of the web enabled client, the rendering image.

5. The method of claim 4, wherein the rendering image includes a bar code identifying said purchase, wherein the bar code is capable of being scanned by a scanner, the method further comprising rendering, using the rendering capabilities of the web enabled client, the bar code on the display with which the web enabled client is in communication.

6. The method of claim 4, wherein said receiving further comprises downloading, using the cellular telephony capability of the web enabled client, a third instruction executable by the web enabled client to instruct, using the near field communication capability of the web enabled client, the portable coupon device to erase the discount information from the memory of the portable coupon device.

7. The method of claim 1, wherein the portable coupon device is a smart card, wherein said writing further comprises communicating with a processor of the smart card to instruct the processor to store the discount information in the memory location.

8. The method of claim 1, wherein the sponsor account is issued to a member of the group comprising:
the merchant selling the purchase;
a manufacturer of the purchase;
a wholesaler of the purchase; and
a distributor of the purchase.

9. A web enabled client comprising:
a browser for browsing to an Internet website in communication with a web service having a database with a plurality of electronic coupons each:
being associated with a sponsor account issued to a sponsor of a discount by one said an issuer; and
for being receivable by a merchant to give the discount on a purchase, wherein the discount is to be debited from the sponsor account and credited to a merchant account issued by another said issuer to the merchant to reimburse the merchant for the discount;
a means for sending from the browser:
a selection of at least one said electronic coupon;
and
a specification including:
a rendering capability of the web enabled client to render a soft copy of the at least one said electronic coupon on a display with which the web enabled client is in communication;
a type of a portable coupon device, associated with one said consumer account issued by another said issuer, and acceptable as payment for a future said purchase to be made on the consumer account;
and
an identifier for the one said consumer account to be debited for the payment for the future said purchase less the discount;
a means for receiving at the browser:
a rendering image corresponding to the rendering capabilities of the web enabled client to render the soft copy of the at least one said electronic coupon on the display with which the web enabled client is in communication;
a memory location to store discount information in a memory of the type of the portable coupon device; and
discount information including an identifier for:
the sponsor account;
the discount amount; and
the purchase that is eligible for the discount from the merchant and including at least one of a good and a service;
and
a means for writing to the memory location in the memory of the portable coupon device the discount information.

10. The web enabled client of claim 9, wherein the rendering image includes a bar code identifying said purchase, the web enabled client further comprising a means for rendering the bar code on the display with which the web enabled client is in communication such that the barcode is capable of being scanned by a scanner.

11. The web enabled client of claim 10, further comprising a memory of the web enabled client for storing the bar code.

12. The web enabled client of claim 11, further comprising a moblet stored in the memory of the web enabled client, wherein the moblet is capable of rendering the bar code on the display.

13. For a payment processing network that includes a plurality of merchants and consumers engaging in a plurality of transactions on a plurality of respective consumer accounts that respective issuers issue to the consumers, each said transaction involving an electronic coupon associated with a sponsor account issued by an issuer, wherein the merchant submits the transaction to an acquirer for processing by a transaction handler who requests the issuer to obtain payment for a discount applied by the merchant to the transaction from the sponsor account, and wherein the issuer forwards the payment to the transaction handler who forwards the payment to the acquirer to reimburse the merchant for the discount given on the transaction, a method comprising:
providing a portable coupon device for reading by a point of service terminal (POS), the portable coupon device:
being associated with one said consumer account issued by one said issuer, and acceptable as payment for a future said purchase to be made on the consumer account, the consumer account;
and
having a memory of the portable coupon device, wherein stored on the memory of the portable coupon device is:
an electronic coupon:
being associated with a sponsor account issued to a sponsor of a discount by one said an issuer; and
for being receivable by one said merchant to give the discount on a purchase, wherein the discount is to be debited from the sponsor account and credited to one said merchant account issued by another said issuer to the one said merchant to reimburse the one said merchant for the discount; and
discount information including an identifier for:
the sponsor account;
a discount amount; and
the purchase that is eligible for the discount from the merchant and including at least one of a good and a service;
wherein the memory of the portable coupon device is to be read, thereby providing the POS with at least part of the discount information sufficient to start the process of:
debiting the consumer account for the price of the purchase less the discount amount; and
debiting the sponsor account for the discount amount; and
crediting the merchant account for the discount amount.

14. The method of claim 13, wherein the portable coupon device is a smart card, wherein to be read the smart card is interrogated by a contactless smart card reader.

15. The method of claim 13, wherein the sponsor account is issued to a member of the group comprising:
the merchant selling the purchase;
a manufacturer of the purchase;
a wholesaler of the purchase; and
a distributor of the purchase.

16. The method of claim 13, further comprising providing a web enabled client having the means for rendering a rendering image associated with the electronic coupon and stored in a memory of the web enabled client on a display with which the web enabled client is in communication.

17. The method of claim 16, wherein the rendering image includes a bar code associated with the electronic coupon, wherein the bar code identifies said purchase, wherein the bar code can be scanned by a scanner of the POS, the method further comprising rendering the bar code on the display with which the web enabled client is in communication.

18. The method of claim 17, wherein said rendering further comprises activating a moblet stored in the memory of the web enabled client.

19. The method of claim 18, further comprising erasing the rendering image from a memory of the web enabled client.

20. The method of claim 19, further comprising instructing, using a near field communication capability of the web enabled client, the portable coupon device to erase the electronic coupon from the memory of the portable coupon device.
